(19) United States
(12) Patent Application Publication
(10) Pub. No.: US 2023/0246164 A1
(43) Pub. Date: Aug. 3, 2023

(54) Customizable Current Collector Surfaces

(71) Applicant: Gridtential Energy, Inc., Santa Clara, CA (US)

(72) Inventors: Collin Kwok-Leung Mui, Mountain View, CA (US); Esteban M. Hinojosa, San Jose, CA (US); Kamran Manteghi, San Jose, CA (US)

(21) Appl. No.: 18/104,737

(22) Filed: Feb. 1, 2023

Related U.S. Application Data
(60) Provisional application No. 63/305,546, filed on Feb. 1, 2022.

(51) Int. Cl. H01M 4/20; H01M 10/12; H01M 4/04; H01M 4/56

(52) U.S. Cl. CPC H01M 4/20; H01M 10/12; H01M 4/0426; H01M 4/0428; H01M 4/045; H01M 4/0404; H01M 4/56; H01M 4/0471

(57) ABSTRACT

A conductive current collector with modified surfaces can be included as a portion of a bipolar battery assembly. The fabrication process can include deposition or formation of a thin film layer such as metal silicide on a surface of the current collector. Metal silicides can be created by co-sputtering or by annealing after deposition of one or more of a silicon or a metal layer. Additional layers can be provided, such as to facilitate adhesion of an active material to a current collector.

### CROSS REFERENCE TO RELATED APPLICATIONS

This non-provisional U.S. utility patent application is related to, and claims priority to, provisional patent application No. 63/305,546 filed Feb. 1, 2022, entitled “Customizable Current Collector Surfaces”, the contents of which are incorporated herein by reference in their entirety.

### TECHNICAL FIELD

Embodiments are related to lead acid batteries and in particular to metal or metal alloy layers on a substrate for a current collector assembly for a lead acid battery.

### BACKGROUND

The lead acid battery, invented by Gaston Planté in 1859, can be regarded as the oldest type of rechargeable battery. Despite having a relatively low energy density as compared to other chemistries, generally available lead acid batteries are simple in construction and economical. Lead acid batteries are used in automotive, traction, and stationary applications such as for ignition or for starting internal combustion engines; for lighting; for applications such as motorized wheelchairs, golf carts, or forklifts; or for other applications such as electrical energy storage when coupled to the electric grid.

Despite relative simplicity and low cost, generally available lead acid technology can suffer from drawbacks. For example, generally available lead acid batteries can provide low energy densities partly because the lead alloy grids used for supporting active material do not generally contribute to energy storage capacity. Also, cycling performance of lead acid batteries can often be poor under high current rate or deep discharge conditions. Lead acid batteries can also suffer from poor partial-state-of-charge performance and can have high self-discharge rates. Such performance characteristics can be traced back at least in part to the configuration of generally available lead acid batteries and can be related to the materials used.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1A is an illustration of a monopolar lead-acid battery.

FIG. 1B is an illustration of a monopolar lead-acid battery.

FIG. 1C is an illustration of a bipolar lead-acid battery.

FIG. 1D is an illustration of a bipolar lead-acid battery.

FIG. 2A is an illustration of an unpasted monopolar plate for use in a lead-acid battery.

FIG. 2B is an illustration of a monopolar plate, with paste applied, for use in a lead-acid battery.

FIG. 3 illustrates a process performed on a substrate for a current collector of a bipolar lead-acid battery.

FIG. 4 illustrates a process performed on a substrate for a current collector of a bipolar lead-acid battery.

FIG. 5 illustrates a process performed on a substrate for use in a current collector of a bipolar lead-acid battery.

FIG. 6 illustrates a process performed on a substrate for use in a current collector of a bipolar lead-acid battery.

FIG. 7 illustrates a process performed on a substrate for use in a current collector of a bipolar lead-acid battery.

FIG. 8 illustrates a process performed on a substrate for use in a current collector of a bipolar lead-acid battery.

FIG. 9 illustrates a process performed on a substrate for use in a current collector of a bipolar lead-acid battery.

### DETAILED DESCRIPTION

As discussed further below, generally available lead acid batteries use a “monopolar” configuration where each current collector or “plate” in the battery comprises a single active material polarity. In another approach, a “bipolar” configuration can be used. In a bipolar architecture, electrochemical cells are generally connected electrically in series. In this configuration, a current collector electronically connects adjacent cells (e.g., through a bulk of a conductive substrate). The adjacent cells are electrochemically isolated, for example, by hermetically sealing each cell. Current collectors, or plates, in the bipolar architecture generally comprise a current collector with positive and negative active materials deposited on opposite sides of the plate, respectively.

The present inventors have recognized that a wafer, for example, a conductive substrate can be processed to include surfaces that are customized to provide different surface characteristics. In one example, the conductive substrate comprises silicon. A monocrystalline or polycrystalline substrate can be doped to achieve a desired level of conductivity (e.g., corresponding to a specified resistivity). The substrate can be etched to prepare its surfaces for further processing. Metal thin films can be deposited on the etched wafer surfaces, and then annealed to form specified metal surfaces. For example, metal thin films can be deposited on etched silicon wafer surfaces to form one or more specified metal silicides. Another thin layer of lead, tin, lead-alloy, or lead-tin alloy, for example, in the form of a thin foil, can be deposited on the metal surfaces, or metal silicide surfaces, of the wafer, such as to facilitate adhesion of a subsequently applied active material layer.

According to the present subject matter, one or more of a lamination technique or a thermal spray technique (e.g., a flame spray technique) can be used to adhere or otherwise bond the thin foil with specified properties to one or both surfaces of a current collector. For example, a single lamination operation can be used to contemporaneously bond foils on both sides of a current collector. Properties of the foil, such as composition, microstructure, surface texture, surface roughness, or thickness can be different between a foil applied to one side of a current collector and a foil applied to the opposite side of the current collector.

Generally, a thermal spray or lamination process as described herein can provide for the thin foil having specified characteristics as applied to a current collector. Such processing can facilitate adhesion of a continuous and void-free active material layer on one or both metal surfaces, or metal silicide surfaces, as the case may be, of the conductive substrate. A resulting clad current collector assembly can provide low electrical resistance in a direction normal (e.g., perpendicular) to the current collector surface, suitable for use in a bipolar configuration. The positive and negative surfaces of the current collector are established to have desired electrochemical properties for their respective active material layer properties and polarities. Optionally, the thin foil surface can be embossed or otherwise textured during the lamination process to establish a specified surface texture or roughness, aiding in subsequent active material layer adhesion (e.g., aiding adhesion of a later-applied paste or other active material layer).

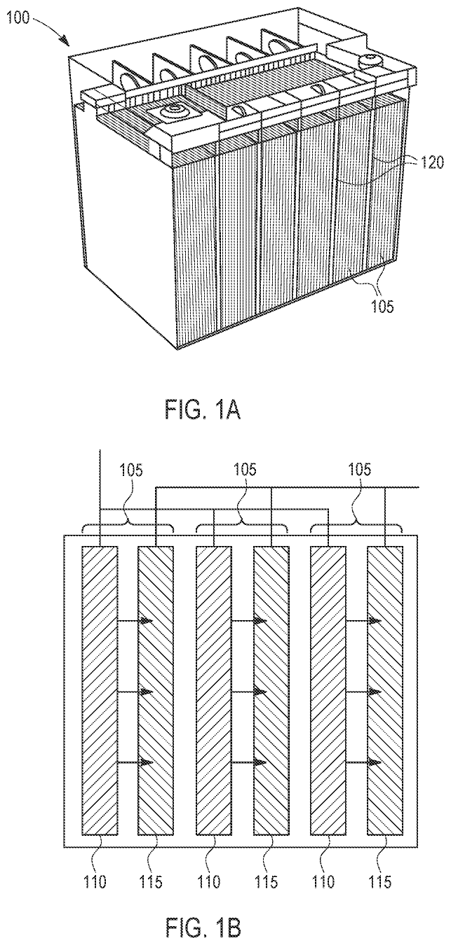

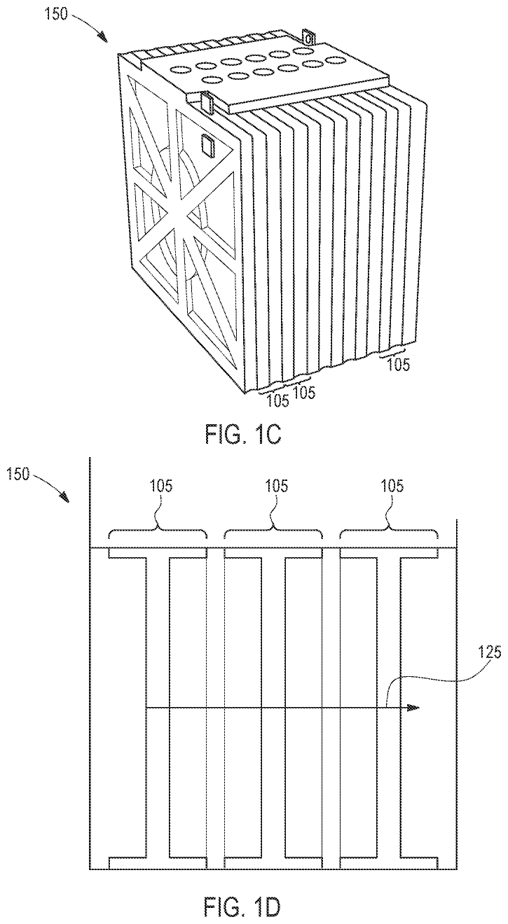

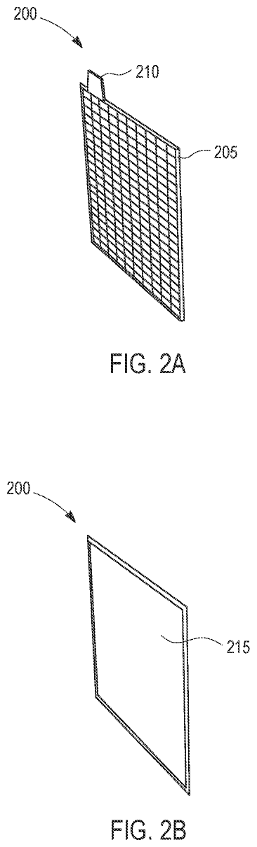

Lead-acid batteries generally use a “monopolar” architecture, where each current collector or “plate” has a specified active material and corresponding single polarity, either positive or negative. A plate in a monopolar lead-acid battery generally includes a lead alloy grid onto which active materials are pasted and cured. Examples 100 of monopolar battery configurations are shown in FIG. 1A and FIG. 1B, in which multiple cells 105 each comprise a positive electrode, or positive plate, 110 and a negative electrode, or negative plate, (e.g., lead plate) 115. The cells are separated by a cell divider 120. A corresponding unpasted monopolar plate 200 is shown in FIG. 2A. A monopolar plate 200 with a paste 215 applied is shown in FIG. 2B. Energy is generated by electrochemical reactions involving active materials and an electrolyte, and current is transported through the monopolar plate or lead “grid” 205 to a contact, such as shown by the tab 210 in FIG. 2. Many lead-acid batteries are application-specific: properties of the pasted electrode such as dimensions, alloy composition of the current collector, or formulation of the active materials, are specified to meet established operating characteristics such as capacity, charge-discharge cycle life, or peak current capability, as illustrative examples.

Generally, in the monopolar configuration, current generated by electrochemical reactions traverses across an alloy grid to a top terminal of the battery. This introduces a non-uniformity of current density across the surface of the current collector. When the battery undergoes deep discharge, active materials on the electrode with the highest current density may be preferentially depleted resulting in non-uniform aging of the respective current collectors. Similar circumstances can occur when the battery undergoes high-current charge or discharge. These phenomena can result in low energy density and poor power performance as compared to other battery chemistries or configurations.

In another approach, a bipolar configuration 150 can be used, such as shown illustratively in FIG. 1C and FIG. 1D. In the bipolar architecture, electrochemical cells 105 are generally connected electrically in series. The current collector connects neighboring cells electronically while an electrolyte between the faces of the active materials is isolated from adjacent cells, for example, by hermetically sealing the cells. Generally, a bipolar plate comprises a current collector with positive and negative polarity active materials deposited on opposite sides of the plate, respectively. When energy is generated in the bipolar battery configuration, current generally flows through a surface of the bipolar plate, and through the bulk of the plate, to the next cell (e.g., perpendicular to the surface of the plate), for example, as indicated by arrow 125 in FIG. 1D. In this sense, a whole surface of the bipolar plate can be used for current collection, with a more uniform current density distribution as compared to a monopolar configuration. Accordingly, a bipolar configuration can provide superior cycle life or power performance as compared to a monopolar configuration.

Characteristics of bipolar batteries are influenced by the materials and processing used for the bipolar current collector assemblies, or, simply, “biplate” assemblies. Generally, a bipolar current collector assembly can be specified to provide an electrically conductive substrate that is mechanically light, resistant to mechanical damage, and resistant to acid corrosion (e.g., sulfuric acid). The current collector substrate is also generally specified to inhibit or suppress electrolyte diffusion to maintain isolation between adjacent cells. The current collector substrate is generally specified to be electrochemically stable within the operating range of the battery chemistry (e.g., lead acid chemistry) and an electrically conductive substrate can also provide thermal conductivity to aid in heat dissipation.

In a bipolar current collector assembly, the respective surfaces or faces of the assembly may have differing properties or processing. For example, a positive surface of a bipolar current collector assembly may develop a corrosion layer with lead dioxide active material, and a negative surface of the current collector assembly may be established to provide elemental lead adhesion and is generally not oxidized. In a monopolar configuration, a positive current collector grid alloy can have elements such as tin (Sn) to facilitate corrosion layer formation, and a negative current collector grid alloy can have calcium (Ca) as a constituent, such as to provide added mechanical strength. In addition to chemical composition, other properties of current collector surface such as microstructure, roughness, or segregation can affect battery performance. In monopolar grid current collectors, these properties can be controlled by the grid manufacturing process, such as casting method, temperature, casting rate, and the like. For a bipolar current collector configuration, the positive and negative surfaces are opposite each other on the same current collector assembly. The present inventors have recognized, among other things, that controlling individual surface properties for the respective surfaces is non-trivial. To address such challenges, such as to provide respective bipolar current collector surfaces having differing processing or composition, the present inventors have recognized that techniques such as shown and described herein can be used.

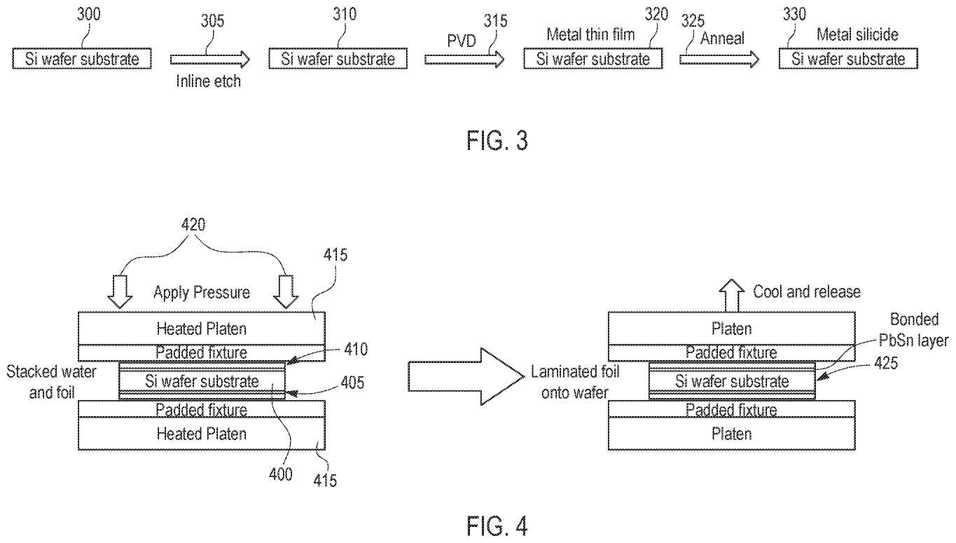

Generally, with reference to FIG. 3, a substrate for a current collector 300 can include a wafer, for example, a silicon wafer, with specified dimensions and thickness for use as a base material. It should be noted that while FIG. 3 illustrates an embodiment of the present subject matter that uses a silicon substrate, embodiments of the present subject matter may use other substrates. For a bipolar lead acid battery, polygonal-shaped, for example, rectangular or square, current collectors up to 100 centimeters in height by 100 centimeters in width can be used, though generally the surface extent of such a current collector may be smaller such as corresponding to a specified battery casing cross section. Lead-acid batteries are generally manufactured in different sizes and shapes, and the example of a rectangular or square surface configuration for the bipolar current collector assembly is merely one approach. A thickness of the current collector substrate can vary from about 100 micrometers to about 2000 micrometers. Larger current collectors—in terms of surface area—are generally thicker. A purity of a wafer base material, for example, the purity of a silicon wafer base material, can be controlled such that impurities in the material do not preclude use in a lead-acid battery configuration. Moreover, specified impurities, known as dopants, can be added to the wafer base material to decrease an electrical resistivity of substrate material to provide a specified bulk conductivity. Suitable dopants include boron, phosphorus, arsenic, or antimony. Dopant concentrations are generally in the range of 1 to 500 parts to million.

The substrate of current collector 300 generally undergoes a cleaning procedure 305 before further processing. The cleaning procedure removes surface contaminations, insulating thin films, and damages on the substrate surface. Common cleaning processes include, but are not limited to organic solvent clean, detergent clean, acid or alkaline etching, or ultrasonic cleaning, yielding a cleaned substrate 310. A metallic thin film 320 can be deposited on one or both sides of the cleaned substrate. In one approach, the wafer is annealed such that the metal thin film forms a metal surface on the substrate. In another approach, a silicon wafer is annealed such that the metal thin film forms a metal silicide with the substrate's surface. Many metals form metal silicides with silicon. Examples of such metals that may be used include titanium (Ti), chromium (Cr), iron (Fe), cobalt (Co), nickel (Ni), copper (Cu), niobium (Nb), molybdenum (Mo), tantalum (Ta), tungsten (W), platinum (Pt), Lithium (Li), and zirconium (Zr). Metal thin films can be deposited by physical vapor deposition (PVD) techniques 315 such as evaporation or sputtering, chemical vapor deposition (CVD), or by electrodeposition techniques such as electroplating.

The annealing 325 of a silicon substrate with metal deposits induces a sintering reaction between the metal thin film and the silicon surface, to form a metal silicide 330 on one or both sides of the silicon substrate.

The annealing process 325 can be performed in a controlled-atmosphere oven, rapid thermal processing (RTP) equipment, or a vacuum oven. The metal surface renders the substrate surface conductive, and compatible with lead-acid electrochemistry. Likewise, the metal silicide surface renders the silicon substrate surface conductive, and compatible with lead-acid electrochemistry.

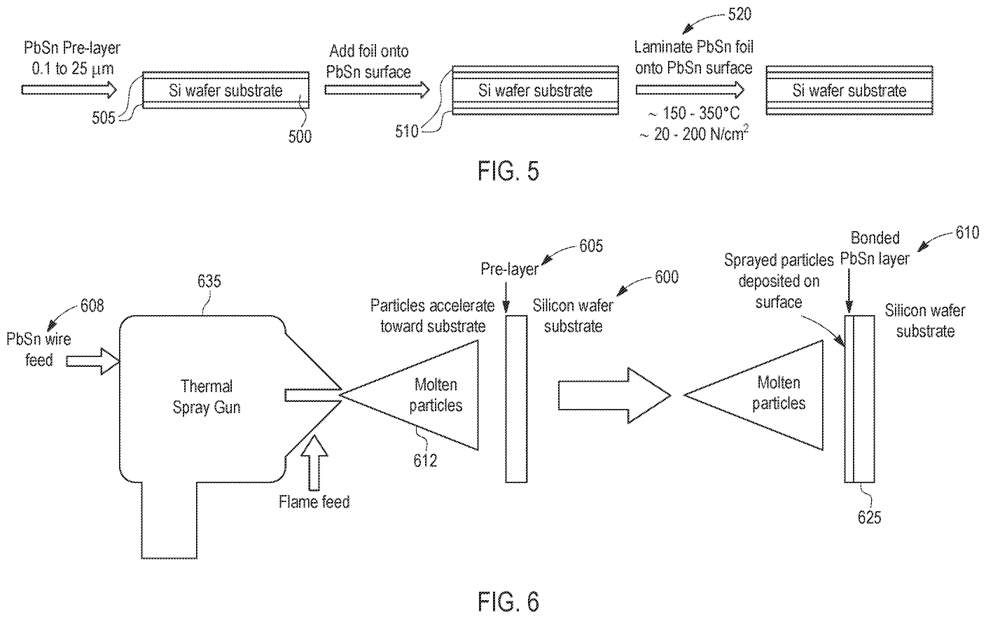

In an example, with reference to FIGS. 4 and 5, a thin layer 405, 505, e.g., of lead, tin, or lead-tin alloy (PbSn) is deposited on a metal surface of the current collector 400, 500. While FIGS. 4 and 5 illustrate an embodiment of the present subject matter that uses a silicon substrate, embodiments of the invention may use other substrates. In the case of a silicon substrate, the thin layer 405, 505, e.g., comprising lead, tin, or lead-tin alloy (PbSn) is deposited on a metal silicide surface of the current collector 400, 500. In one embodiment the thin layer 405, 505 is deposited on both sides of the current collector 400, 500. As an illustration, a thickness of the lead-tin alloy film can be as thin as 0.1 micrometer or may be a up to 0.25 micrometer. This thin layer can be referred to as a “pre-layer” 405, 505 and can be deposited by physical vapor deposition or by electroplating. In electroplating, the thin layer can be referred to as a seed, a strike, or a flash layer. The deposition process parameters are established such that the pre-layer 405, 505 is thin, dense, and adheres strongly to the metal surface (or metal silicide surface) of the current collector 400, 500. This pre-layer 405, 505 can serve as a “seed” layer or foundation for subsequent deposition, lamination, or coating processes.

Generally, an alloy composition of the pre-layer 405, 505 may have less stringent requirements as compared to the final surface of the current collector 400, 500. The pre-layer 405, 505 can be pure lead, pure tin, or a tin-lead composition such as including but not limited to 95%-5% PbSn, 90%-10% PbSn, 50%-50% PbSn, or 38%-62% eutectic PbSn, as illustrative examples. Pure lead generally provides good corrosion resistance, whereas pure tin or a eutectic blend can provide a lower melting point than elemental lead alone.

Generally, different layers are applied to the positive versus negative electrode sides of the current collector 400, 500. For example, as few as a single lamination process can be sufficient to apply different materials at different thicknesses contemporaneously, to the two opposing sides of the current collector 400, 500. In another example, separate processing is used for each side. In an example, lead, or lead alloy, foils (also referred to herein as “thin foils”) 410, 510 of the different compositions or thicknesses are “laminated” or otherwise applied to the two sides of the current collector 400, 500 such as shown illustratively in FIGS. 4 and 5.

Lamination, in this context, can be understood as a process by which the lead alloy foil 410, 510 is bonded to the current collector 400, 500 surface with thermal and/or compressive forces, such as using platen structures 415. During the lamination process, atoms in the lead alloy foil 410, 510 diffuse into the crystalline substrate 400, 500 as depicted at 425. Thin foils with different compositions or thicknesses can be bonded onto the current collector 400 contemporaneously, such as by placing different thin foils 410, 510 or thin foil stacks 410, 510 on opposite sides of the current collector 400, 500, before applying pressure as depicted at 420, 520 with platen structures 415. Generally, surfaces of the current collector 400, 500, and the thin foils 410, 510 are cleaned or otherwise prepared to remove contaminants before the bonding process. In one embodiment, one or both platens 415 are heated. The lamination platen temperature is generally below the melting point of lead, such as established at a temperature in the range of 150° C. to 350° C. The pressure used to bond the thin foils 410, 510 to the surface of the current collector 400, 500 can be established at a value or range of values selected from the range of 20 to 200 N/cm². Lamination parameters can be specified to provide a homogeneous and void free layer having specified contact resistance. A positive electrode surface of the current collector, which adheres to lead dioxide active materials, is typically a lead-tin alloy with <2.5% tin in the lead-tin alloy, and the thin foil 410, 510 can have a thickness in the range of 25 to 500 micrometers, as illustrative examples. The negative electrode surface of the current collector 400, 500 can be a pure lead thin foil without any alloying elements.

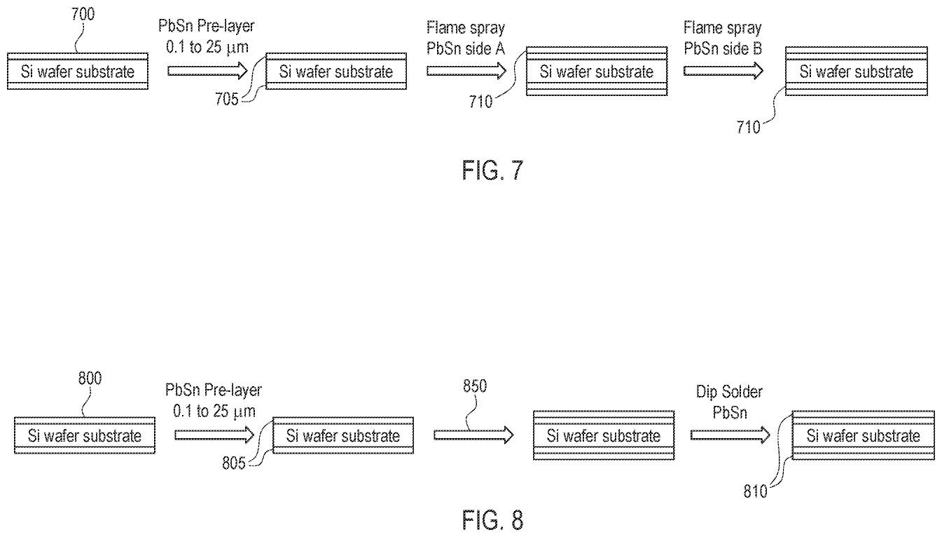

In another example, with reference to FIGS. 6 and 7, a lead-tin alloy thin foil 610, 710 can be deposited on the pre-layer 605, 705 of the current collector 600, 700 using a thermal spray gun 635 performing, e.g., a flame spraying technique. While FIGS. 6 and 7 illustrate an embodiment of the present subject matter that uses a silicon substrate, embodiments of the present subject matter need not be so limited. In flame spraying, the lead-tin alloy feedstock, in the form of wire or powder 608, can be heated to nebulize, and can then be accelerated as depicted at 612 toward the current collector surface to form a deposit of thin foil on the pre-layer 605, 705. Flame spraying works effectively for metals with low melting points (like lead and its alloys for example) and can offer higher deposition rate as compared to other deposition processes such as electroplating. The composition of the deposited thin foil 610, 710 is largely determined by the feedstock. To deposit different alloys of thin foil 610, 710 with different thicknesses onto the positive and negative sides of the current collector 600, 700, two flame spray operations with different feedstock alloys and deposition durations can be used. Feedstock properties such as wire or powder size, and process parameters such as time, temperature and spray particle velocity, can be used to independently adjust thickness, density, and porosity of the thin foil 610, 710 deposited on each side of the current collector 600. During the flame spraying process, atoms in the thin foil 610 diffuse into the crystalline substrate 600, 700 as depicted at 625.

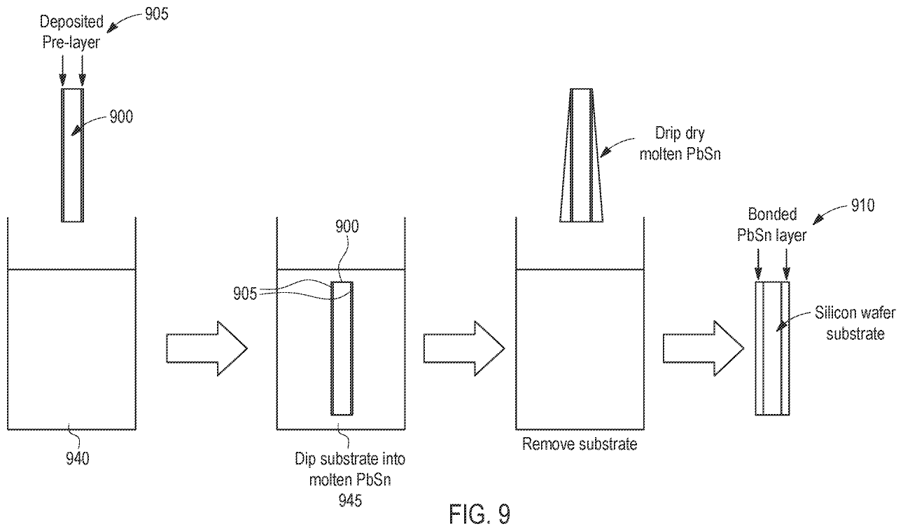

In another example, a lead-tin alloyed thin foil 810, 910 can be coated on a seed layer 805, 905 of the current collector 800, 900 by a dip process, shown illustratively in FIG. 8 and FIG. 9. While FIGS. 8 and 9 illustrate an embodiment of the present subject matter that uses a silicon substrate, embodiments of the present subject matter may use other substrates. This can be accomplished by dipping the seeded-current-collector into a heated bath of molten lead-tin alloy 940 as depicted at 945. The current collector can be treated with cleaning flux as depicted at 850 before the dipping process to facilitate wetting or adhesion. During the dip coating process 945, the molten lead-tin alloy wets the seed layer surface 805, 905 of the current collector 800, 900 to apply a coated layer of the alloy 810, 910 onto the seed layer 805, 905 as the thin foil. In this example, composition of both sides of the current collector 800, 900 are generally the same, though a masking approach could be used to suppress wetting on a portion or an entirety of one of the current collector surfaces. Coating thickness and other parameters can be adjusted such as by modulating dip speed or duration, for example.

Examples above mention use of a pre-layer, though such a layer is not necessarily required. For example, pure lead or lead-alloy layers can be formed directly on metal surfaces, or metal silicide surfaces by lamination, thermal spraying, or dip coating. In these examples, a metal surface, or metal silicide surface of the current collector is cleaned prior to application of a lead or lead-alloy thin foil in order to improve adhesion.

As described above, the positive and negative electrode of the current collector may use different alloy composition and thicknesses. Generally, corrosion occurs only at the positive electrode. Accordingly, the thickness of the thin foil on the positive electrode surface or side of the current collector can be specified to be within a range of 50 to 500 micrometers thick, and the thickness of the thin foil on the negative electrode side of the current collector can have a thinner layer, such as about 25 micrometers thick. In one embodiment, to provide such an asymmetric thickness, deposition of the pre-layer is continued until the required thickness on the negative electrode side is achieved. Then, one of the aforementioned processes, in particular lamination or flame spraying, is used to apply additional lead alloy onto the positive electrode side of the current collector to provide an overall lead alloy thickness that is greater on the positive electrode side of the current collector as compared to the negative electrode side.

The above detailed description includes references to the accompanying drawings, which form a part of the detailed description. The drawings show, by way of illustration, specific embodiments in which the invention can be practiced. These embodiments are also referred to generally as “examples.” Such examples can include additional or different elements to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in a claim are still deemed to fall within the scope of that claim. Moreover, in the following aspects, the terms “first,” “second,” and “third,” etc., are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The abstract is provided to allow the reader to quickly ascertain the nature of the technical disclosure. It is submitted with the understanding that it will not be used to interpret or limit the scope or meaning of the claims. Also, in the above detailed description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following aspects are hereby incorporated into the detailed description as examples or embodiments, with each aspect standing on its own as a separate embodiment, and it is contemplated that such embodiments can be combined with each other in various combinations or permutations.

1. A method for creating a clad current collector assembly, comprising:
doping an electrically conductive monocrystalline or polycrystalline substrate for a current collector (hereinafter “the substrate”) to a specified level of electrical conductivity;
depositing a metal film on surfaces of the substrate;
annealing the deposited metal films to form metal surfaces on the substrate;
depositing one or more of a lead, tin, lead-alloy, or lead-tin alloy foil (hereinafter “the thin foil”) on the metal surfaces of the substrate; and
bonding the thin foil on the metal surfaces of the substrate.

2. The method of claim 1, wherein the substrate comprises a silicon wafer having a thickness of 100 to 2000 micrometers.

3. The method of claim 1, wherein doping the substrate comprises doping the substrate with a dopant selected from a group consisting of: boron, phosphorus, arsenic, and antimony, wherein a concentration of the dopant ranges from 1 to 500 parts per million.

4. The method of claim 1, further comprising, before depositing the metal film on the surfaces of the substrate, cleaning the surfaces of the substrate, wherein cleaning surfaces of the substrate comprises on or more of removing surface contaminations, removing insulating thin films, and removing damages on a surface of the substrate, using an organic solvent, a detergent, acid etching, alkaline etching, or ultrasonic cleaning.

5. The method of claim 1, wherein depositing the metal film on surfaces of the substrate comprises depositing the metal film according to a selected one or more of a group of techniques consisting of: physical vapor deposition (PVD) including evaporation or sputtering, chemical vapor deposition (CVD), and electrodeposition including electroplating.

6. The method of claim 1, wherein the metal film is selected from a group consisting of: titanium (Ti), chromium (Cr), iron (Fe), cobalt (Co), nickel (Ni), copper (Cu), niobium (Nb), molybdenum (Mo), tantalum (Ta), tungsten (W), platinum (Pt), Lithium (Li), and zirconium (Zr)).

7. The method of claim 1, wherein annealing is performed in or by one of a controlled-atmosphere oven, rapid thermal processing (RTP) equipment, and a vacuum oven.

8. The method of claim 1, wherein the annealing induces a sintering reaction between the deposited metal film and the surface of the substrate to form the metal surface on the substrate.

9. The method of claim 1, wherein depositing the metal film on the surfaces of the substrate comprises depositing by controlled-atmosphere oven, rapid thermal processing (RTP) equipment, or a vacuum oven.

10. The method of claim 1, wherein the specified thickness of the thin foil is in a range of 25 to 500 micrometers.

11. The method of claim 1, wherein the specified composition of the thin foil is selected from a group consisting of: lead, tin, lead-alloy, and lead-tin alloy.

12. The method of claim 1, further comprising depositing a seed layer on one or both of the metal surfaces on the substrate wherein the specified composition of the seed layer is selected from a group consisting of: pure lead, pure tin, and a lead-tin alloy having a composition of 95%-5% PbSn, 90%-10% PbSn, 50%-50% PbSn, or 38%-62% eutectic PbSn;
wherein depositing the thin foil on the metal surfaces of the substrate comprises depositing the thin foil on the seed layers of the substrate; and
wherein bonding the thin foil on the metal surfaces of the substrate comprises bonding the thin foil on the seed layers of the substrate.

13. The method of claim 1, wherein depositing the thin foil on the metal surfaces of the substrate comprises depositing the thin foil on the metal surfaces of the substrate to facilitate adhesion of a continuous and void-free active material layer on one or both metal surfaces of the conductive substrate.

14. The method of claim 1, wherein bonding the thin foil on one or both metal surfaces of the substrate comprises bonding the thin foil on one or both metal surfaces of the substrate according a process selected from a group of processes consisting of: laminating the thin foils on one or both metal surfaces with one or both of a thermal force with a temperature range of 150° C. to 350° C.) and a compressive force of 20 to 200 N/cm2, using a platen structure; thermal spraying the thin foils on one or both metal surfaces; and dip coating the substrate in a heated bath of molten lead, tin, lead-alloy, or lead-tin alloy.

15. The method of claim 1, wherein specified properties of the thin foil are selected from a group of specified properties consisting of: a composition, a microstructure, a surface texture, a surface roughness, and a thickness of the thin foil.

16. The method of claim 15, wherein the specified properties of the thin foil differ when bonded to one metal surface of the substrate relative to the other metal surface of the substrate to yield a thin foil of 50 to 100 micrometers thickness on one metal surface of the substrate and to yield a thin foil of approximately 25 micrometers thickness on the other metal surface of the substrate.

17. The method of claim 1, wherein the clad current collector assembly provides a low electrical resistance in a direction normal to a surface of the clad current collector assembly for use in a bipolar lead-acid battery.

18. A current collector assembly for a bipolar battery made by the process recited in claim 1.

19. A device comprising a bipolar battery having a clad current collector assembly made by the process recited in claim 1.

20. The method of claim 1, wherein the monocrystalline or polycrystalline substrate comprises a monocrystalline or polycrystalline silicon substrate;
wherein doping the substrate to the specified level of electrical conductivity comprises doping an electrically conductive monocrystalline or polycrystalline silicon substrate for the current collector (hereinafter “the silicon substrate”) to the specified level of electrical conductivity;
wherein depositing the metal film on surfaces of the substrate comprises depositing the metal film of the surfaces of the silicon substrate;
wherein annealing the deposited metal films to form metal surfaces on the substrate comprises annealing the deposited metal films to form metal silicide surfaces on the silicon substrate;
wherein depositing thin foil on the metal surfaces of the substrate comprises depositing thin foil on the metal silicide surfaces of the silicon substrate; and
wherein bonding the thin foil on the metal surfaces of the substrate comprises bonding the thin foil on the metal silicide surfaces of the silicon substrate.
